(19) United States
(12) Patent Application Publication
(10) Pub. No.: US 2019/0129971 A1
(43) Pub. Date: May 2, 2019

(54) STORAGE SYSTEM AND METHOD OF CONTROLLING STORAGE SYSTEM

(71) Applicant: Hitachi, Ltd., Tokyo (JP)

(72) Inventors: Kazuei HIRONAKA, Tokyo (JP); Akira YAMAMOTO, Tokyo (JP); Tomohiro KAWAGUCHI, Tokyo (JP)

(21) Appl. No.: 16/122,907

(22) Filed: Sep. 6, 2018

(30) Foreign Application Priority Data
Oct. 27, 2017 (JP) 2017-207840

(51) Int. Cl. G06F 17/30

(52) U.S. Cl. CPC G06F 17/30156; G06F 17/30371

(57) ABSTRACT

A storage system having a deduplication function that stores a plurality pieces of data having duplicated content as one piece of data in a storage device, the storage system includes a processor and a controller including a memory, in which the controller includes a deduplication processing/address conversion unit which creates a first volume corresponding to an external device that transmits a write request and a read request and a second volume corresponding to the storage device, and converts an address of data deduplicated between the first volume and the second volume, and a deduplication determination unit which investigates a duplication level of each area of the first volume, and determines whether deduplication for each area is necessary, and the controller performs access control to the storage device based on the determination as to whether the deduplication is necessary.

### CLAIM OF PRIORITY

The present application claims priority from Japanese patent application JP 2017-207840 filed on Oct. 27, 2017, the content of which is hereby incorporated by reference into this application.

### BACKGROUND OF THE INVENTION

### 1. Field of the Invention

The present invention relates to data processing performed by a storage system having a deduplication function.

### 2. Description of the Related Art

A storage system having a deduplication function is well-known by the public (for example, WO 2016/046911 A).

### SUMMARY OF THE INVENTION

In recent years, the amount of data accumulated in a company rapidly increases, and thus there is a strong need for a storage system that can store a large amount of data at low cost. For this reason, a data-amount reduction technique that is capable of reducing the amount of data stored in a storage device, and reducing operation cost and initial cost of a storage system has attracted attention.

As such a data-amount reduction technique, there is a deduplication technique for reducing data stored in a storage by detecting redundant data strings of the data stored in the storage and eliminating the redundant data strings.

In a deduplication technique as described above, when the storage system detects a duplicated data, the storage system will manage the associated logical address to the shared data which is concurrently referred from another logical address. Thus, the data stored in the storage is stored at plurality of addresses in the storage system irrelevantly to the data order written by the host.

For this reason, in order for the host to read the data stored in the storage, it requires to restore the data stored at the addresses in the storage system to the original order of the data stored in the storage system by the host. Since the procedure in restoring the data string is required, I/O processing in the storage system that performs deduplication is costly when processing the related deduplication as compared with a storage system not having the deduplication technology, and eventually the I/O performance is degraded.

The data reduction effect obtained by the deduplication technology as described above greatly varies depending on the characteristics of data to be processed and the usage of a storage system. For example, in a virtualization environment of a server, such as Virtual desktop infrastructure (VDI) or Virtual machine (VM), or of a personal computer (PC), a plurality of images of one operating system (OS) is copied and assigned to individual usage or users. In such usage, since data stored in the storage system are duplicated according to the number of times of copying, the data reduction effect is expected to be high. Meanwhile, in the usage as a database which has been common as the usage of a storage system, a unique identification number or the like is assigned to each pieces of data stored in the storage system by a host. For this reason, even though the data is same content in the database software operating on the host, the storage system handles the data as different data, and the data reduction effect by the deduplication technology is smaller.

As described above, the deduplication technique causes, in principle, the overhead of the I/O processing related to the deduplication processing, and data reduction effect is depending on the characteristics of the data to be processed and the usage of a storage system. Thus, in order to effectively use the deduplication technique in the storage system, it is desirable not to perform the deduplication processing in the case where the processing data can not deduplicate. This is to prevent I/O performance degradation caused by the deduplication processing.

The present invention has been made in view of the above problems, and is to reduce the overhead of deduplication processing and to prevent I/O performance degradation.

The present invention provides a storage system which has a deduplication function that stores plurality of the data having duplicated content as one piece of data in a storage device, the storage system includes a processor and a controller including a memory, in which the controller includes a deduplication processing/address conversion unit which creates a first volume corresponding to an external device that transmits a write request and a read request and a second volume corresponding to the storage device, and converts an address of data deduplicated between the first volume and the second volume, and a deduplication determination unit which investigates duplication level of each area of the first volume, and determines whether deduplication for each area is necessary, and the controller performs access control to the storage device based on the determination as to whether the deduplication is necessary.

According to the representative embodiment of the present invention, in a storage system to which a deduplication technique is applied, it is possible to reduce processing overhead caused by deduplication processing to the target data or usage for which reduction of the data amount by the deduplication processing is not effective, and to improve the I/O processing performance of the storage system. Problems, configurations, and effects other than those described above will be clarified from the description of the following embodiment.

### BRIEF DESCRIPTION OF THE DRAWINGS

FIG. 1 is a block diagram showing an embodiment of the present invention and a configuration of an entire storage system;

FIG. 2 is a diagram showing the embodiment of the present invention and an example of a logical device configuration of the storage system;

FIG. 3A is a diagram showing the embodiment of the present invention and an example of a data state before deduplication processing;

FIG. 3B is a diagram showing the embodiment of the present invention and an example of a data state after deduplication processing;

FIG. 4A is a diagram showing an example of the problem of the present invention and an example of deduplication processing;

FIG. 4B is a diagram showing the embodiment of the present invention and an example of I/O processing;

FIG. 5 is a block diagram showing the embodiment of the present invention and a configuration of management information;

FIG. 6 is a diagram showing the embodiment of the present invention and an example of a configuration of an HDEV management table;

FIG. 7 is a diagram showing the embodiment of the present invention and an example of a configuration of a pool table;

FIG. 8 is a diagram showing the embodiment of the present invention and an example of a configuration of a pool VOL table;

FIG. 9 is a diagram showing the embodiment of the present invention and an example of a configuration of an HDEV logical/physical table;

FIG. 10 is a diagram showing the embodiment of the present invention and an example of a configuration of an HDEV physical/logical table;

FIG. 11 is a diagram showing the embodiment of the present invention and an example of a configuration of a page mapping table;

FIG. 12 is a diagram showing the embodiment of the present invention and an example of a configuration of a reduction area table;

FIG. 13 is a diagram showing the embodiment of the present invention and an example of a configuration of a hash table;

FIG. 14A is a diagram showing the embodiment of the present invention and an example of an HDEV-duplication-level information table;

FIG. 14B is a diagram showing the embodiment of the present invention and an example of an HDEV-duplication-level detail information table;

FIG. 15 is a flow chart showing the embodiment of the present invention and an example of processing of a duplication-level investigation unit;

FIG. 16 is a flowchart showing the embodiment of the present invention and an example of processing of a deduplication ON/OFF determination unit; and

FIG. 17 is a flowchart showing the embodiment of the present invention and an example of processing for accepting a command from a host and setting effectiveness or ineffectiveness of deduplication processing.

### DESCRIPTION OF THE PREFERRED EMBODIMENTS

Hereinafter, an embodiment of the present invention is described with reference to the accompanying drawings.

### First Embodiment

An embodiment of the present invention is described below with reference to the drawings.

Note that, the embodiment to be described below does not limit the invention according to claims, and all combinations of elements described in the embodiment are not necessarily indispensable for solving means of the invention. In the following description, various types of information may be described as expressions such as “xxx table”, “xxx list”, “xxx DB”, “xxx queue” and the like, but the various types of information may be expressed as data structures other than “table”, “list”, “DB”, and the like. Thus, in order to indicate that information does not depend on a data structure, “xxx table”, “xxx list”, “xxx DB”, “xxx queue” or the like can be referred to as “xxx information”.

In addition, an expression such as “identification information”, “identifier”, “name”, or “ID” is used for describing the content of each information, but these expressions can be replaced with each other.

Furthermore, the embodiment of the present invention to be described later may be implemented by software operating on a general-purpose computer, dedicated hardware, or a combination of software and hardware.

Moreover, processing can be described using “program” as a subject in the following description, but a program executes predetermined processing using a storage resource (for example, a memory), a communication I/F, and a port by a processor (for example, a central processing unit (CPU)) executing the program, and thus a processor may be used as a subject.

The processing described using a program as the subject may be processing performed by a computer including a processor (for example, a calculation host or a storage device). In addition, in the following description, the expression “controller” may be a hardware circuit that performs a part or all of a processor or processing performed by a processor.

Programs may be installed in each computer from a program source (for example, a program distribution server or a computer-readable storage medium). In this case, the program distribution server includes a CPU and a storage resource, and the storage resource stores distribution programs and programs to be distributed. Then, the CPU of the program distribution server distributes a program to be distributed to the other computers by the CPU executing the distribution program.

Furthermore, in the following description, the term “PDEV” means a physical storage device, and typically may be a nonvolatile storage device (for example, an auxiliary storage device). A PDEV may be, for example, a hard disk drive (HDD) or a solid state drive (SSD). Different types of PDEVs may coexist in a storage system.

Moreover, in the following description, the term “RAID” stands for Redundant array of independent (or inexpensive) disks. A RAID group is constituted by a plurality of PDEVs (typically, the same type of PDEVs), and stores data in accordance with the RAID level associated with the RAID group. A RAID group may be referred to as a parity group. A parity group may be, for example, a RAID group that stores parity.

In the following description, the term “VOL” stands for a logical volume and may be a logical storage device. A VOL may be a substantial VOL (RVOL) or a virtual VOL (VVOL). An “RVOL” may be a VOL based on a physical storage resource (for example, one or more RAID groups) included in a storage system having the RVOL.

A “VVOL” may be any one of an external connection VOL (EVOL), a capacity expansion VOL (TPVOL), and a snapshot VOL. An EVOL may be a VOL that is based on a storage space (for example, a VOL) of an external storage system and conforms to a storage virtualization technology.

A TPVOL may be a VOL that is constituted by a plurality of virtual areas (virtual storage areas) and conforms to a capacity virtualization technology (typically, Thin provisioning). A snapshot VOL may be a VOL provided as a snapshot of the original VOL. A snapshot VOL may be an RVOL.

The term “pool” is a logical storage area (for example, a collection of a plurality of pool VOLs) and may be prepared for each usage. For example, as a pool, there may be at least one of a TP pool and a snapshot pool. A TP pool may be a storage area constituted by a plurality of pages (substantive storage areas).

When pages are not allocated to the virtual area (virtual area of a TPVOL) to which the address specified by a write request received from a host system (hereinafter, a host) belongs, a storage controller allocates pages to the virtual area (virtual area of the write destination) from a TP pool (pages may be newly allocated to the virtual area of the write destination although pages have been allocated to the virtual area of the write destination).

The storage controller may write data to be written according to the write request in the allocated pages. A snapshot pool may be a storage area in which data evacuated from the original VOL is stored. One pool may be used both as a TP pool and as a snapshot pool. The term “pool VOL” may be a VOL that is a constituent element of a pool. A pool VOL may be an RVOL or an EVOL.

In the following description, a VOL recognized by the host (VOL provided to the host) is referred to as an “HDEV”. In the following description, an HDEV is a TPVOL (or RVOL), and a pool is a TP pool. However, the present invention is applicable to a storage system not employing the capacity expansion technology (Thin provisioning).

In addition, in the following description, an in-line system is adopted as a deduplication system. However, other deduplication systems of, for example, a post-processing system, or a combination of an in-line system and a post-processing system may be adopted in the present invention.

Note that, the “in-line system” is a system for deduplicating data before writing the data in a storage device (for example, an HDEV or a PDEV). The “post-processing system” is a system for deduplicating data asynchronously after writing the data in a storage device.

In the following description, data is deduplicated in a data-chunk unit. Hereinafter, a data chunk can be simply referred to as a “chunk”. In the embodiment, a chunk may have a variable length or a fixed length.

Before describing the embodiment of the present invention, the outline of the embodiment is described with reference to the drawings.

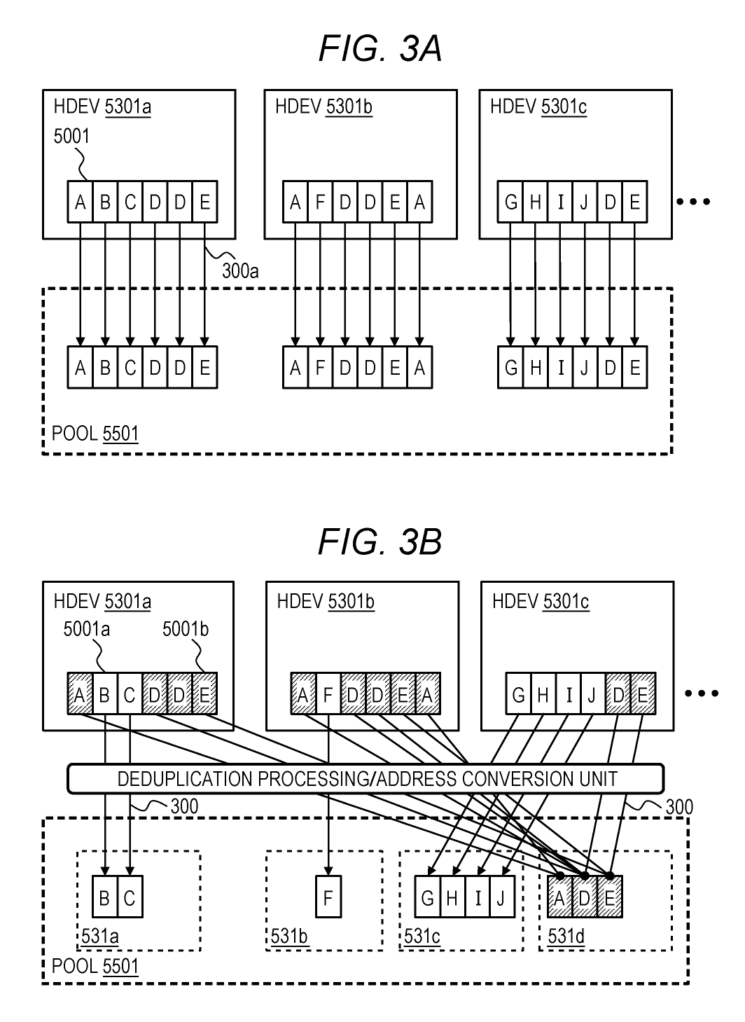

FIGS. 3A and 3B are diagrams showing that chunks 5001 written by a host 1003 in a logical volume 5301 are stored in areas of a pool 5501. FIG. 3A is a diagram showing an example of a data state before deduplication processing. FIG. 3B is a diagram showing an example of a data state after deduplication processing.

FIG. 3A shows the arrangement relationship between logical addresses and data stored in the pool 5501 when deduplication processing is not performed. The chunks 5001 written by the host 1003 in an HDEV 5301a, an HDEV 5301b, and an HDEV 5301c are subjected to multiple times of address conversion in a storage system 2000, and stored in areas of the pool 5501. Then, the storage addresses and the addresses in the HDEV 5031a, the HDEV 5031b, and the HDEV 5031c are associated using pointers 300a.

At this time, the order of the chunks stored in the pool 5501 is maintained as the order in which the host 1003 has written the data in the HDEV 5301a, the HDEV 5301b, and the HDEV 5301c.

For example, when the host 1003 accesses the data written in the HDEV 5301a, the storage system 2000 needs to perform the processing for converting the addresses in the pool 5501 to a chunk A (chunk having the content A) in order to access the chunk 5001 stored in the corresponding pool 5501. Since a chunk B and a chunk C following the chunk A are arranged in consecutive address areas, the processing for converting the addresses can be performed by relative addition and subtraction processing from the chunk A.

FIG. 3B shows the arrangement relationship between logical addresses and data stored in the pool 5501 when deduplication processing is performed. Similarly to FIG. 3A, the chunks 5001 written by the host 1003 in the HDEV 5301a, the HDEV 5301b, and the HDEV 5301c are subjected to multiple times of address conversion in the storage system 2000, and stored in areas of the pool 5501.

At this time, by performing processing of a deduplication processing/address conversion unit 6000, the content of the chunks written by the host 1003 is investigated, and chunks having duplicated content are detected. When the content does not match other chunks like a chunk 5001a, the deduplication processing/address conversion unit 6000 stores the chunk 5001a in an ST (non-shared) area 531a of the pool 5501 that stores a chunk the content of which does not match other chunks, and associates the storage address with the address in the HDEV 5301 using the pointer 300.

On the other hand, when the content matches another chunk like a chunk 5001b, the deduplication processing/address conversion unit 6000 stores the chunk 5001b in a DS (data sharing) area 531d of the pool 5501. Then, the deduplication processing/address conversion unit 6000 associates, using the pointers 300, the storage addresses with the addresses of the chunks that share the content in a plurality of HDEVs 5301. In this manner, the deduplication processing/address conversion unit 6000 inhibits duplicated chunks having the same content from being stored, and reduces chunks to be stored in the pool 5501.

In the following description, the DS area 531d and all the ST areas 531a to 531c are referred to as a reduction area 531.

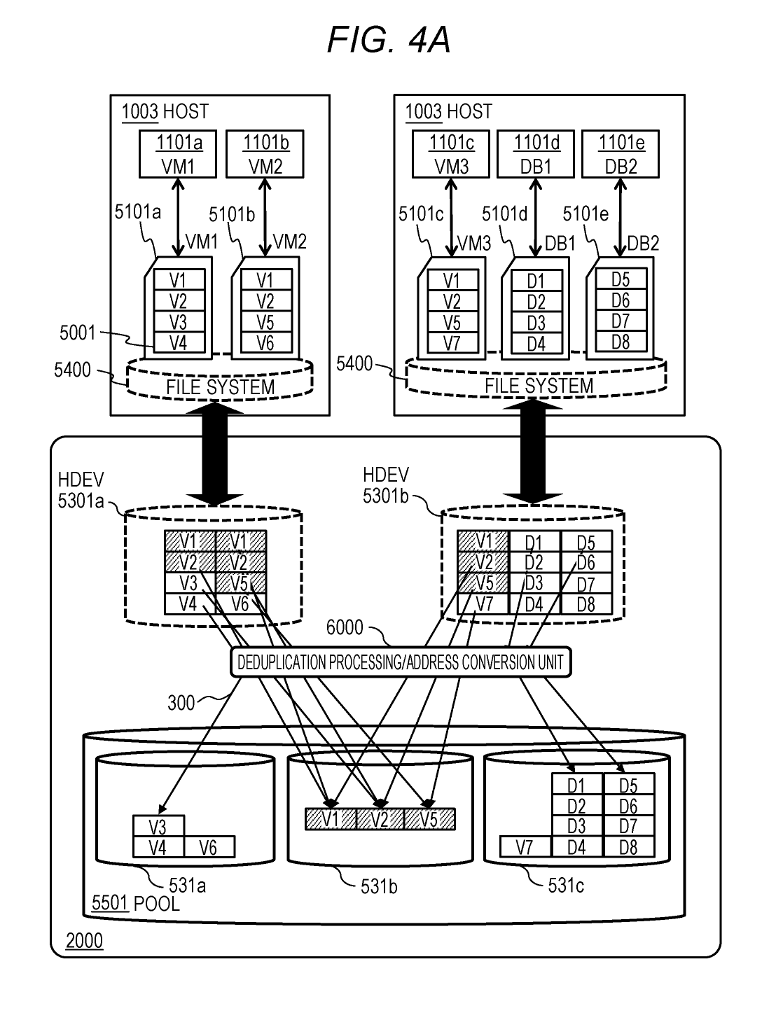

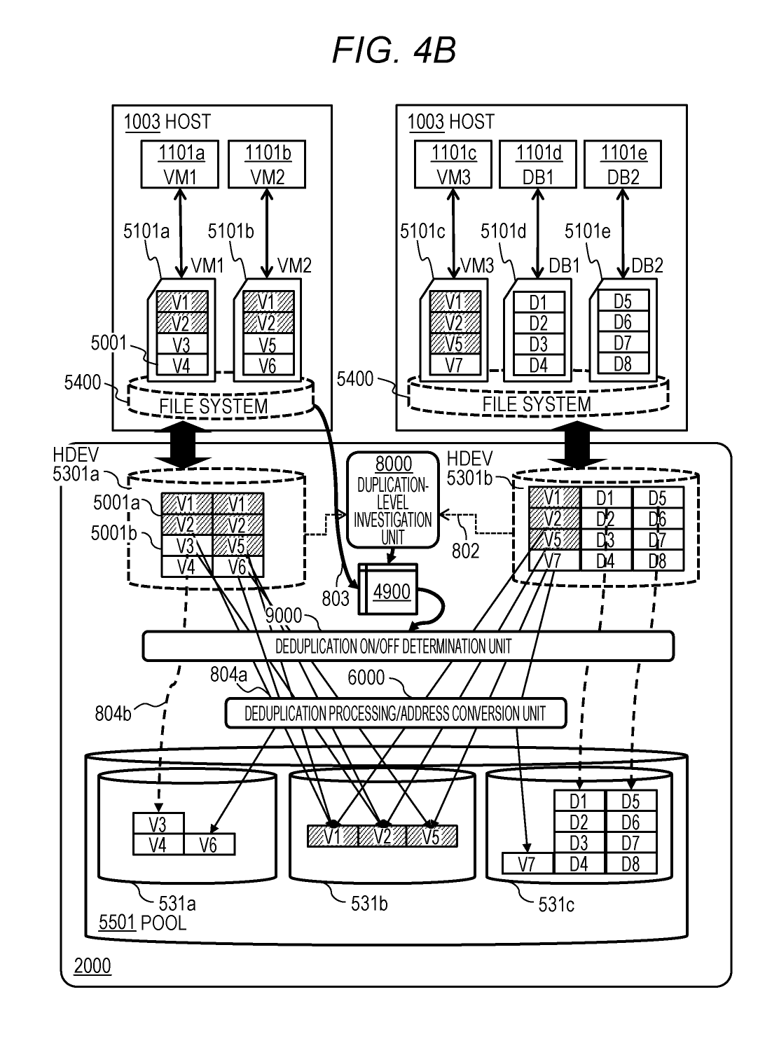

FIG. 4A is a diagram explaining the problem of the present invention in a storage system that performs deduplication processing.

In the host 1003, an OS, a virtual machine (VM) hypervisor, and the like operate, and VMs 1101a, 1101b, and 1101c, database applications 1101d and 1101e, and the like also operate.

These VMs and DB applications access the HDEVs 5301 provided by the storage system 2000 via files 5101a to 5101e storing disk images constructed on a file system 5400 provided by the OS or the VM hypervisor software and data to be used by applications of the databases and VMs.

With the deduplication processing described with reference to FIG. 3B, when the data containing the files 5101a to 5101e and management information of the file system 5400 is stored in the HDEV 5301 of the storage system 2000 by the host 1003, the deduplication processing/address conversion unit 6000 stores, in the ST areas 531a and 531c of the pool 5501, chunks the content of which does not match the other chunks in the HDEV 5301 and in the other HDEVs 5301. In addition, the deduplication processing/address conversion unit 6000 stores, in the DS area 531b of the pool 5501, chunks the content of which matches the other chunks in the HDEV 5301 or in the other HDEVs 5301 (the hatched portions in the drawing).

Here, when attention is focused on the chunks contained in the files 5101a and 5101e of the file system 5400 of the host 1003 and the chunks contained in the HDEVs 5301a and 5301b corresponding to these chunks, there are files containing the hatched chunks to be subjected to the deduplication processing in the HDEVs 5301a and 5301b, and files containing no hatched chunk.

In the storage system 2000, the effectiveness or ineffectiveness of the deduplication processing is controlled in a unit of the HDEV 5301a or the HDEV 5301b, and the deduplication processing/address conversion unit 6000 performs the deduplication processing to all the chunks contained in the HDEV 5300 for which the deduplication processing is effective.

For this reason, in the case, for example, where the files 5101d and 5101e are DB files focusing on the I/O performance of the storage and there is no effect of data reduction by deduplication, the deduplication processing/address conversion unit 6000 cannot recognize the units of the files 5101a to 5101e managed by the file system 5400 of the host 1003.

Thus, in order for the host 1003 to access the chunks in the pool 5501 corresponding to the files, the deduplication processing/address conversion unit 6000 always needs to convert the addresses in the HDEV 5301 and the addresses in the pool 5501. For this reason, the problem that I/O performance is deteriorated is caused by this processing overhead has arisen.

FIG. 4B is a diagram explaining the solution to the problem in the present embodiment described with reference to FIG. 4A in a storage system that performs deduplication processing. In FIG. 4B, a duplication-level investigation unit 8000 and a deduplication ON/OFF determination unit 9000 are further provided. The duplication-level investigation unit 8000 and the deduplication ON/OFF determination unit 9000 are included in a control program 3000A (3000B), loaded into a DRAM 2002A (2002B), and executed by a CPU 2001A (2001B).

The duplication-level investigation unit 8000 regularly accesses the data stored by the host 1003 in the HDEVs 5301a and 5301b and acquires the type of the file system 5400 of the host 1003 using the HDEVs 5301a and 5301b. Then, the duplication-level investigation unit 8000 recognizes the files 5101a to 5101e stored in the file system 5400, investigates the duplication ratio of data (chunk=access unit) for each HDEV 5300 and the duplication ratio of each of the files 5101a to 5101e (802), and stores the investigation result in an HDEV-duplication-level information table 4900.

The deduplication ON/OFF determination unit 9000 determines, based on the information of the HDEV-duplication-level information table 4900, ON (permission) or OFF (prohibition) of the deduplication processing for each chunk 5001 of the HDEVs 5301 at the time of the I/O processing. When determining the deduplication processing to be ON, the deduplication ON/OFF determination unit 9000 selects an I/O processing route 804a that passes through the deduplication processing/address conversion unit 6000. On the other hand, when determining the deduplication processing to be OFF, the deduplication ON/OFF determination unit 9000 prohibits the processing in the deduplication processing/address conversion unit 6000, and selects an I/O processing route 804b that accesses the reduction area 531.

Based on the determination result of the deduplication ON/OFF determination unit 9000, the I/O processing for the chunk 5001a to which ON (permission) of the deduplication processing is set is performed via the deduplication processing/address conversion unit 6000.

On the other hand, the chunk 5001b to which OFF of the deduplication is set is directly subjected to the I/O processing in a reduction LBA of the ST area 531a corresponding to a virtual LBA of the HDEV 5301a. When the duplication ratio is low and the deduplication is changed from ON to OFF, data movement processing for copying the data related to the chunk 5001b from the DS area 531b to the ST area 531a is performed to directly perform the I/O processing, and the I/O processing is directly started after the processing. This processing is unnecessary when the duplication ratio is 0%. By providing the deduplication ON/OFF determination unit 9000 that determines whether the deduplication is effective or ineffective in this manner, when a plurality of files 5101c to 5101e having different usage or data characteristics such as the HDEV 5301b is included in the file system 5400, the deduplication for the chunk belonging to the file 5101c to which the deduplication is effective is set to ON (permission) based on the investigation result of the duplication-level investigation unit 8000, and thus the data amount is reduced by the deduplication processing.

On the other hand, the deduplication ON/OFF determination unit 9000 sets, to OFF (prohibition), the deduplication for the chunk belonging to the files 5101d and 5101e for which the deduplication is not effective, and thus the chunk is directly stored in the reduction LBA of the ST area 531c in the pool 5501 corresponding to the virtual LBA of the HDEV 5301b not via the deduplication processing/address conversion unit 6000.

This makes it possible to flexibly select the area to be subjected to the deduplication processing compared with a conventional system in which ON/OFF of deduplication is set only in an HDEV unit, and it is possible to reduce the overhead of the processing related to deduplication processing such as duplication determination and address conversion, and to improve the efficiency of I/O processing.

As described above, in the present embodiment, the deduplication ON/OFF determination unit 9000 that controls ON/OFF of deduplication in an access unit of I/O processing (for example, a chunk) based on the result of the investigation of the duplication ratio of data (chunk or file) is added to the deduplication processing/address conversion unit 6000 that controls ON/OFF of deduplication in a logical volume (HDEV 5301) unit.

Thus, since the deduplication processing/address conversion unit 6000 prohibits the deduplication processing for the chunk belonging to a file for which deduplication is not effective, the chunk is stored in the ST area 531c of the pool 5501 corresponding to a logical volume and can be directly accessed not via the deduplication processing/address conversion unit 6000 although the logical volume for which deduplication processing is effective. Accordingly, it is possible to reduce the overhead of the processing related to deduplication processing such as duplication determination and address conversion, and to improve the efficiency of I/O processing.

Note that, the deduplication processing/address conversion unit 6000 includes a deduplication program and an address conversion program and is loaded into the DRAM 2100A and executed by the CPU 2001A. Similarly, the deduplication ON/OFF determination unit 9000 includes a deduplication switching determination program and is loaded into the DRAM 2100A and executed by the CPU 2001A. The deduplication program, the address conversion program, and the deduplication switch determination program are included in the control program 3000A (3000B) as described above.

Hereinafter, the present embodiment is described in detail.

### Entire System Configuration

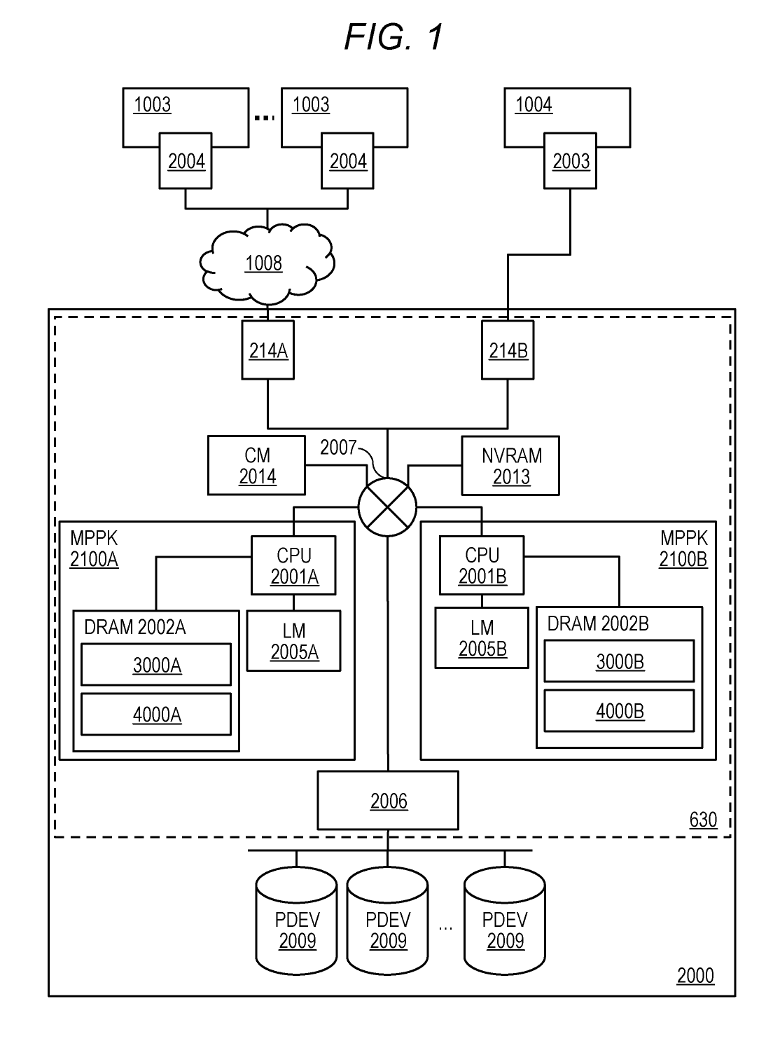

FIG. 1 shows an example of a configuration of the entire system according to the present embodiment.

One or more hosts 1003A to 1003D are connected to the storage system 2000 via a network 1008. Furthermore, a management server 1004 is connected to the storage system 2000. The hosts 1003A to 1003D are denoted by a reference sign 1003 unless identified.

The hosts 1003A to 1003D each stand for a host system, and are one or more hosts. In the following description, the hosts 1003A to 1003D are denoted by a reference sign 1003 unless identified.

The host 1003 includes a host interface device (H-I/F) 2004, and transmits an access request (write request or read request) to the storage system 2000 via the H-I/F 2004, or receives a response to the access request (for example, a write response including write completion or a read response including a chunk to be read). The H-I/F 2004 is, for example, a host bus adapter (HBA) or a network interface card (NIC).

The management server 1004 is an example of a management system and manages the configuration and state of the storage system 2000. The management server 1004 includes a management interface device (M-I/F) 2003, and transmits an instruction to the storage system 2000 or receives a response to the instruction via the M-I/F 2003. The M-I/F 2003 is, for example, an NIC.

The storage system 2000 includes a plurality of PDEVs 2009 and a storage controller 630 connected to the PDEVs 2009. One or more RAID groups including the PDEVs 2009 may be constituted.

The storage controller 630 includes front end interface devices (F-I/F) 214A and 214B, a back end interface device (B-I/F) 2006, a cache memory (CM) 2014, a non-volatile RAM (NVRAM) 2013, micro processor packages (MPPK) 2100A and 2100B, and a repeater 2007 that repeats communication between these elements. The repeater 2007 is, for example, a bus or a switch.

The F-I/Fs 214A and 214B each are an I/F that communicates with the host 1003 or the management server 1004. The B-I/F 2006 is an I/F that communicates with the PDEVs 2009. The B-I/F 2006 may include an E/D circuit (a hardware circuit for encryption and decryption). Specifically, the B-I/F 2006 may include, for example, a serial attached SCSI (SAS) controller, and the SAS controller may include an E/D circuit.

The CM 2014 is constituted by, for example, a dynamic random access memory (DRAM). Data to be written in the PDEVs 2009 or data read from the PDEVs 2009 is temporarily stored in the CM 2014 by the MPPKs 2100. In the NVRAM 2013, data (for example, dirty data (data not written in the PDEVs 2009)) in the CM 2014 is saved by the MPPK 2100 that has received power from a battery (not shown) at the time of power shutdown.

A cluster is constituted by the MPPK 2100A and 2100B. The MPPK 2100A (2100B) includes a memory (the DRAM 2002A (2002B), a local memory (LM) 2005A (2005B)), and the CPU 2001A (2001B) connected thereto.

The DRAM 2002A (2002B) stores the control program 3000A (3000B) to be executed by the CPU 2001A (2001B) and management information 4000A (4000B) to be referred to or updated by the CPU 2001A (2001B).

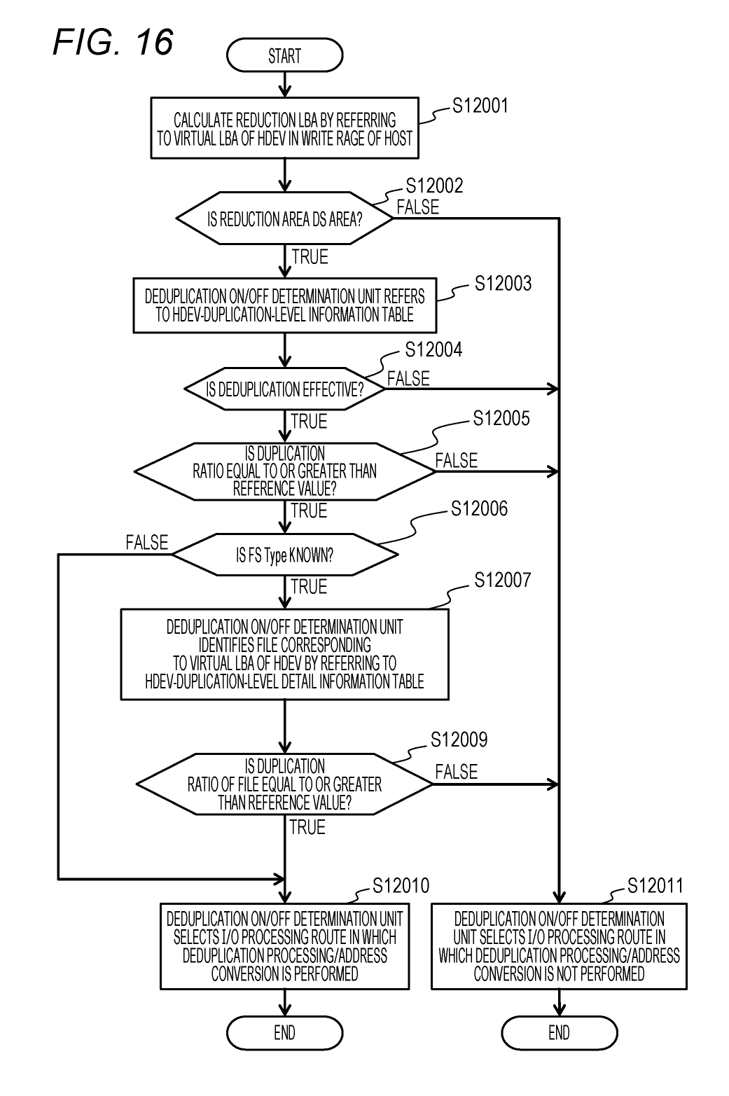

The CPU 2001A (2001B) executes the control program 3000A (3000B), and thus at least a part of the processing described with reference to FIGS. 16 to 21 (for example, deduplication and conversion of relations between virtual addresses) is executed. At least one of the control program 3000A (3000B) and the management information 4000A (4000B) may be stored in a storage area (for example, the CM 2014) shared by the MPPKs 2100A and 2100B. The LM 2005A (2005B) stores chunks.

Note that, the CPU 2001A (2001B) functions as the control unit of the storage controller 630 by executing the control program 3000A (3000B).

Specifically, for example, the LM 2005A (2005B) stores at least one of a chunk to be written in the PDEV 2009 by the MPPK 2100A (2100B), a chunk read from the PDEV 2009 by the MPPK 2100A (2100B), a chunk to be transferred to the MPPK 2100A (2100B), a chunk received from the MPPK 2100B (2100A), and a chunk decompressed by the MPPK 2100A (2100B).

<Logical Device Configuration of Storage System 2000>

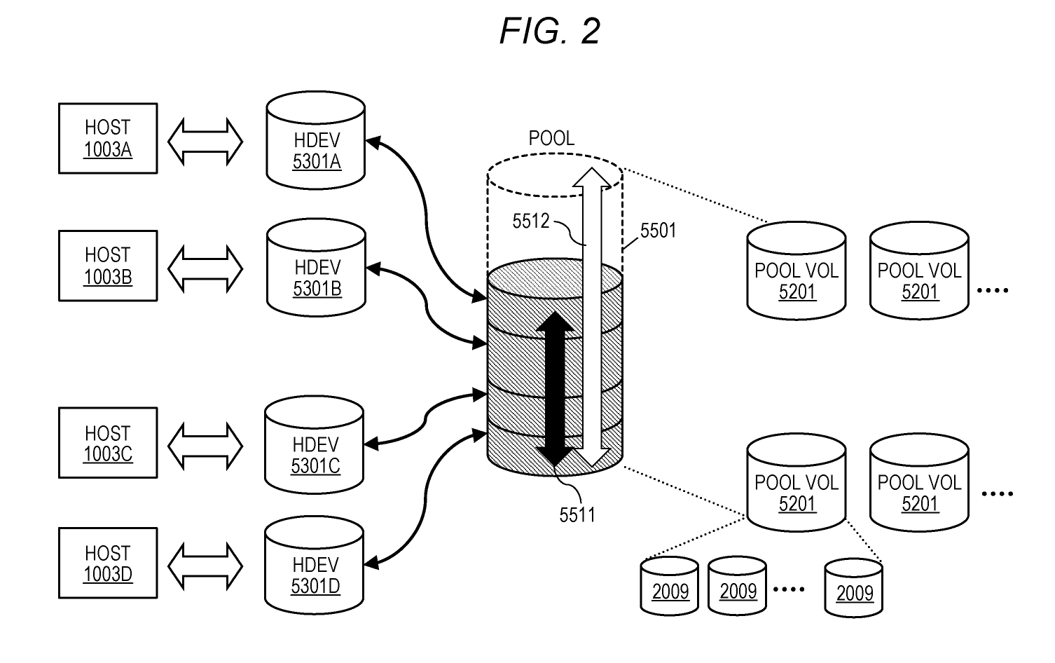

FIG. 2 shows an example of a logical device configuration of the storage system 2000.

The HDEVs 5301A to 5301D are provided to the hosts 1003A to 1003D, respectively. Pages are allocated from the pool 5501 to the HDEV 5301. The pool 5501 is a collection of a plurality of pool VOLs 5201.

Each pool VOL 5201 is a VOL based on one or more PDEVs 2009. In the pool 5501, an arrow 5512 indicates the pool capacity (the capacity of the entire pool), and an arrow 5511 indicates the pool allocation capacity (the capacity of the entire page group allocated to one or more HDEVs 5301). The storage system 2000 may include a plurality of pools 5501.

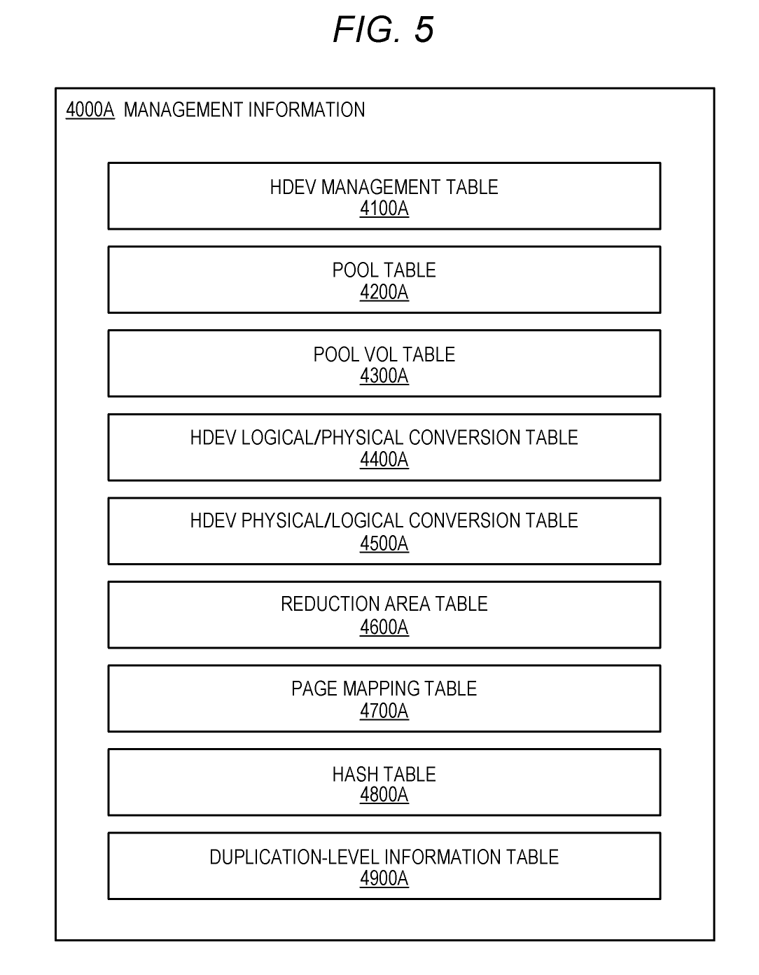

FIG. 5 shows an example of the configuration of the management information 4000A.

The management information 4000A includes a plurality of management tables. The management table includes, for example, an HDEV management table 4100A holding information on the HDEV 5301, a pool table 4200A holding information on the pool 5501, a pool VOL table 4300A holding information on the pool VOLs 5201, an HDEV logical/physical conversion table 4400A for converting logical address information of the HDEV 5301 into physical address information corresponding to the logical address, an HDEV physical/logical conversion table 4500A for converting physical address information of the HDEV 5301 into logical address information corresponding to the physical address, a page mapping table 4700A for mapping between a virtual area and a page, a reduction area table 4600A holding information on the reduction area 531, a hash table 4800A for holding hash values of chunks, and an HDEV-duplication-level information table 4900A storing information to be used by the duplication-level investigation unit 8000 for duplication level investigation of the HDEV 5301. At least a part of the information may be synchronized between the management information 4000A and 4000B.

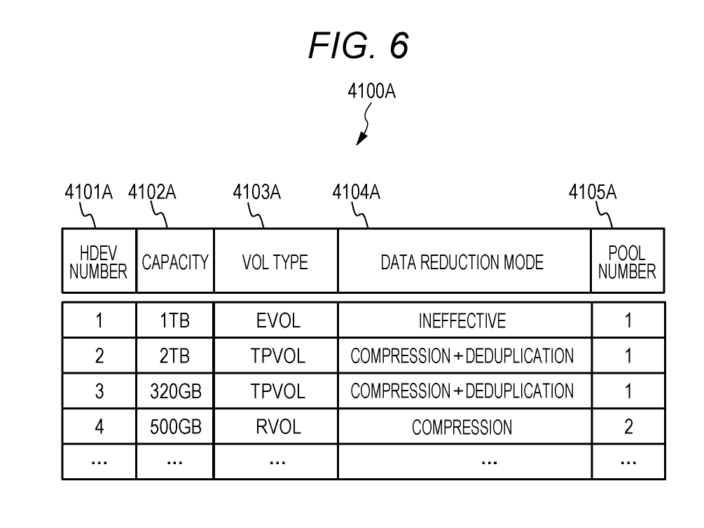

FIG. 6 shows an example of the configuration of the HDEV management table 4100A.

The HDEV management table 4100A has an entry (record) for each HDEV 5301. The information stored in each entry includes an HDEV number 4101A, an HDEV capacity 4102A, a VOL type 4103A, a data reduction mode 4104A, and a pool number 4105A.

The HDEV number 4101A indicates the identification number of the HDEV 5301. The HDEV capacity 4102A indicates the capacity of the HDEV 5301. The VOL type 4103A indicates the type of HDEV (for example, “RVOL” or “TPVOL”). The data reduction mode 4104A indicates the reduction type of the data stored in the HDEV 5301. The data reduction mode 4104A includes “compression”, “deduplication”, “compression+deduplication” (to perform compression and deduplication), and “ineffective” (to perform neither compression nor deduplication).

The pool number 4105A indicates the identification number of the pool 5501 with which the HDEV 5301 is associated, and the HDEV 5301 is allocated with a data storage area from the area of the pool 5501 with which the HDEV 5301 is associated.

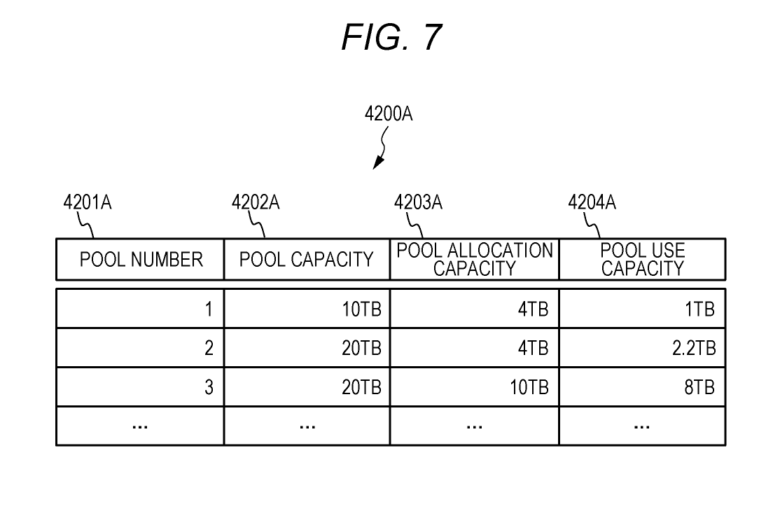

FIG. 7 shows an example of the configuration of the pool table 4200A.

The pool table 4200A has an entry for each pool 5501. The information stored in each entry includes a pool number 4201A, a pool capacity 4202A, a pool allocation capacity 4203A, and a pool use capacity 4204A.

The pool number 4301A indicates the identification number of the pool 5501. The pool capacity 4302 indicates the defined capacity of the pool 5501, that is, the total capacity of one or more VOLs corresponding to one or more pool VOLs 5201 constituting the pool 5501 (the capacity indicated by the arrow 5512 in FIG. 2).

The pool allocation capacity 4303A indicates the real capacity allocated to one or more HDEVs 5301, that is, the capacity of the entire page group allocated to one or more HDEVs 5301 (the capacity indicated by the arrow 5511 in FIG. 2). The pool use capacity 4304A indicates the total amount of data stored in the pool 5501. When data reduction (at least one of compression and deduplication) is performed to the data, the pool use capacity 4304A may be calculated by the MPPK 2100A based on the data amount after the data reduction.

When the PDEV 2009 performs data compression, the MPPK 2100A may calculate the pool use capacity 4304A based on the data amount before the compression, or may receive a notification of the data amount after the compression from the PDEV 2009 and calculate the pool use capacity 4304A based on the data amount after the compression.

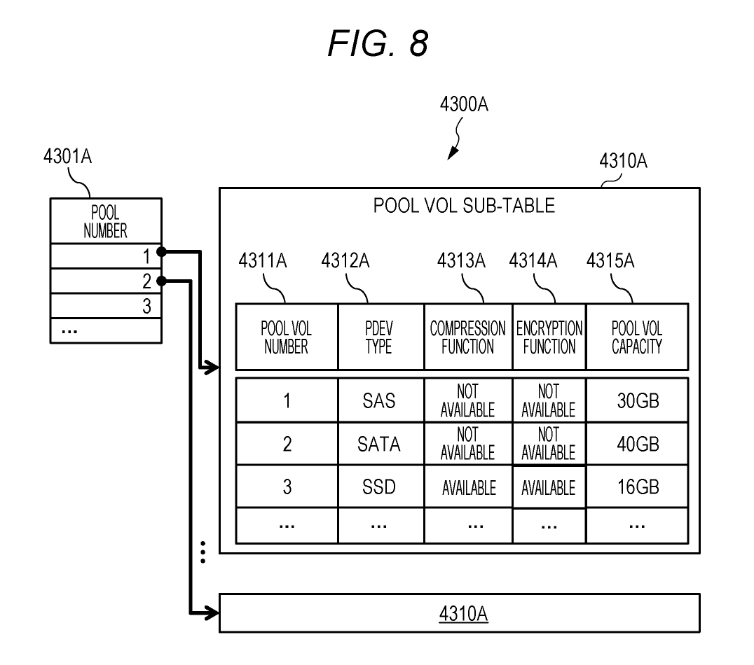

FIG. 8 shows an example of the configuration of the pool VOL table 4300A.

The pool VOL table 4300A includes a list of pool numbers 4301A and a pool VOL sub-table 4310A for each pool number 4301A. The pool VOL sub-table 4310A has an entry for each pool VOL 5201 in the pool 5501. The information stored in each entry includes a pool VOL number 4311A, a PDEV type 4312A, a compression function 4313A, an encryption function 4314A, and a pool VOL capacity 4315A.

The pool VOL number 4311A indicates the identification number of the pool VOL 5201. The PDEV type 4312A indicates the type of the PDEV 2009 which is the base of the pool VOL 5201. The compression function 4313A is a flag indicating whether the PDEV 2009 which is the base of the pool VOL 5201 has a compression function.

The encryption function 4314A is a flag indicating whether the PDEV 2009 which is the base of the pool VOL 5201 has an encryption function. The pool VOL capacity 4315A indicates the capacity of the pool VOL 5201.

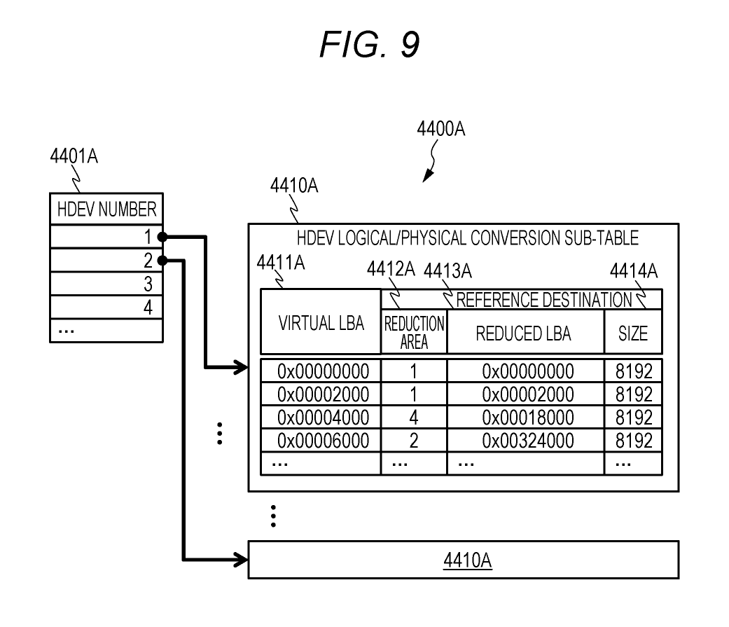

FIG. 9 shows an example of the configuration of the HDEV logical/physical conversion table 4400A.

The HDEV logical/physical conversion table 4400A is a table referred to in order to convert the virtual LBA of the HDEV 5301 into the reduction area 531 and the reduction LBA of the pool 5501. In the HDEV logical/physical conversion table 4400A, an HDEV logical/physical conversion sub-table 4410 corresponding to each entry of the HDEV number 4401A is generated. The information stored in each entry of the HDEV logical/physical conversion sub-table 4410A includes an identifier of a virtual LBA 4411A, a reduction area 4412A, a reduction LBA 4413A, and a size 4414A.

The HDEV number 4401A indicates the identification number of the HDEV. The virtual LBA 4411A indicates the LBA of the HDEV 5300. The reduction area 4412A indicates the identification number of the reduction area 531 corresponding to the virtual LBA 4411A. The reduction LBA 4413A indicates the reduction LBA corresponding to the virtual LBA 4411A after conversion.

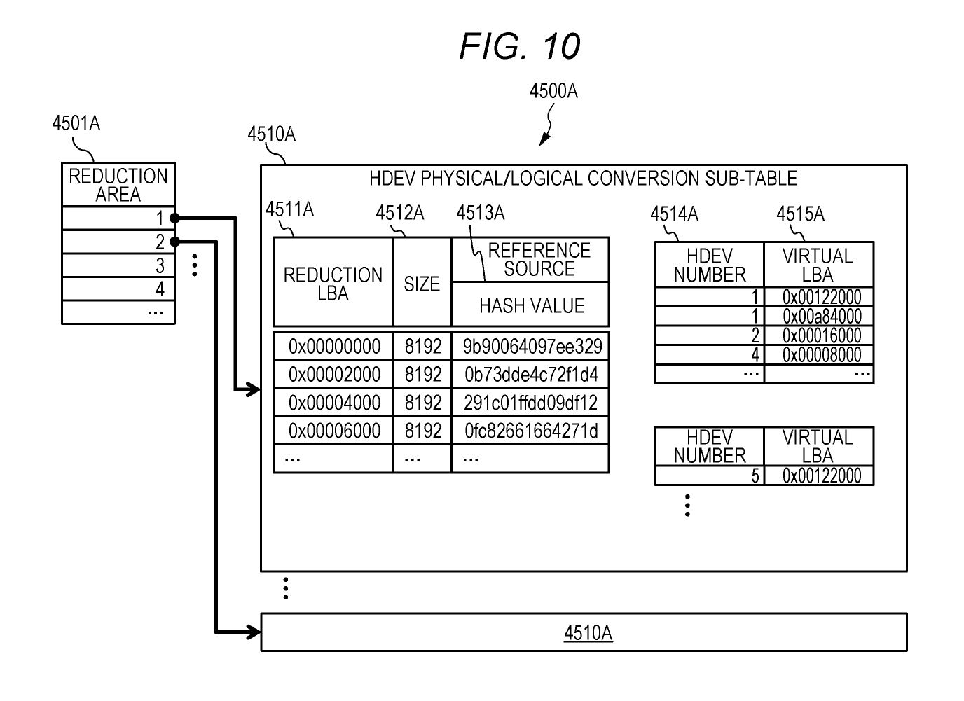

FIG. 10 shows the configuration of the HDEV physical/logical conversion table 4500A.

The HDEV physical/logical conversion table 4500A is a table referred to in order to convert the reduction LBA into the HDEV 5300 allocated to the reduction LBA and the virtual LBA.

The HDEV physical/logical conversion table 4500A includes an HDEV physical/logical conversion sub-table 4510A corresponding to each entry of the reduction area 4501A. The information stored in each entry of the HDEV physical/logical conversion sub-table 4510 includes a reduction LBA 4511A, a size 4512A, and a hash value 4513A based on the content of the chunk stored in the LBA.

The HDEV physical/logical conversion sub-table 4510 further includes a list of a HDEV number 4514A and a virtual LBA 4515A corresponding to each entry of the reduction LBA 4511A. In the list, for example, whereas a plurality of HDEV numbers and the corresponding virtual LBAs are associated for a reduction LBA storing chunks shared with other areas, one HDEV number and one corresponding virtual LBA are associated for a reduction LBA storing chunks not shared with other areas.

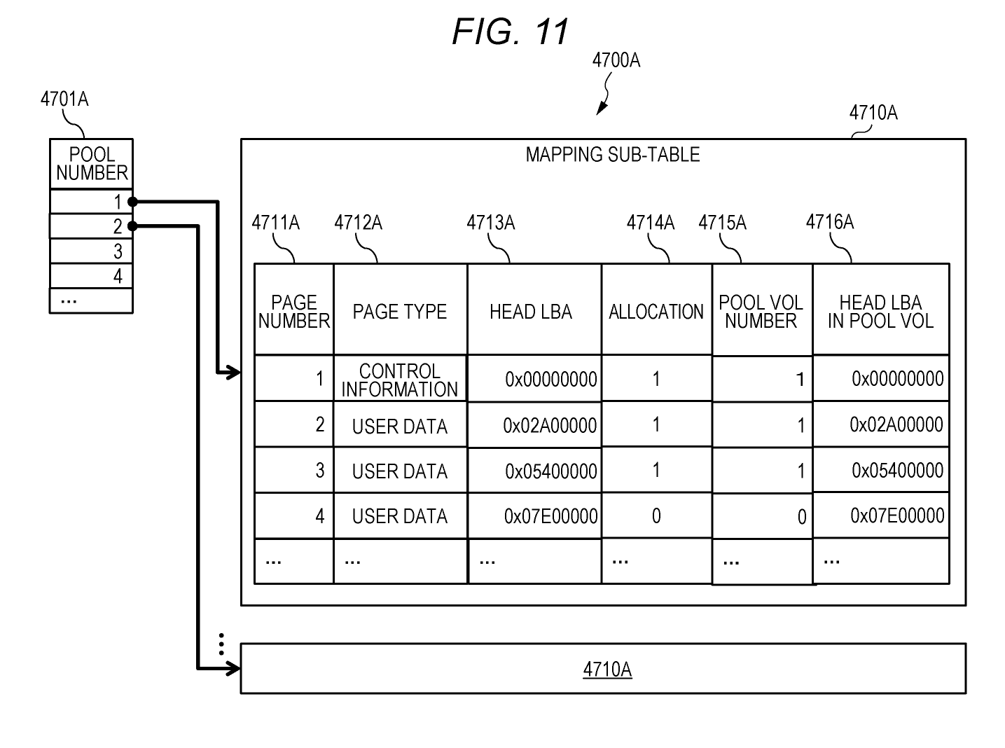

FIG. 11 shows an example of the configuration of the page mapping table 4700A.

The page mapping table 4700A includes a list of pool numbers 4701A, and a mapping sub-table 4710A for each pool number 4701A. The mapping sub-table 4710A has an entry for each page in the pool 5501.

The information stored in each entry includes a page number 4711A, a page type 4712A, a head LBA 4713A, allocation 4714A, a pool VOL number 4715A, and a head LBA in pool VOL 4716A.

The pool number 4701A indicates the identification number of the pool 5501. The page number 4711A indicates the identification number of the page. The page type 4712 indicates the type of data stored in the page. The head LBA 4713A indicates the head pool LBA of the page (LBA in the case of using the head of the pool 5501 as a reference). The allocation 4714A is a flag indicating whether the page is allocated (“1”) to the HDEV 5301 or not (“0”). The pool VOL number 4715A indicates the identification number of the pool VOL 5201 including the page.

The head LBA in the pool VOL 4716A indicates the LBA in the pool VOL 5201 of the LBA indicated by the head LBA 4713A (the LBA in the case of using the head of the pool VOL 5201 as a reference).

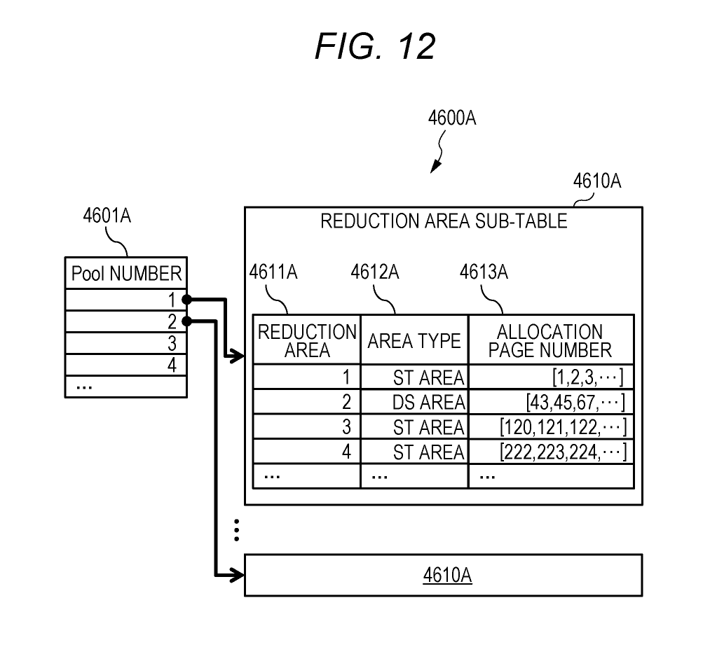

FIG. 12 shows an example of the configuration of the reduction area table 4600A.

The reduction area table 4600A includes a reduction area sub-table 4610A for each entry of the pool number 4601A. The information stored in each entry of the reduction area sub-table 4610A includes a reduction area 4611A, an area type 4612A, and a page allocation number 4613A.

The pool number 4601A indicates the identification number of the pool 5501. The reduction area 4611A in the reduction area sub-table 4610A indicates the identification number of the reduction area 531. The area type 4612A indicates the type of the area of the reduction area 531, such as an ST area storing chunks that do not share data with other areas corresponding to the HDEV 5300, a DS area storing chunks that share data with a plurality of HDEV 5300 and other areas, or the like. The page allocation number 4613A indicates the list of the page numbers 4711A (see the mapping sub-table 4710A in FIG. 11) in the pool 5501 allocated to the reduction area 4611A.

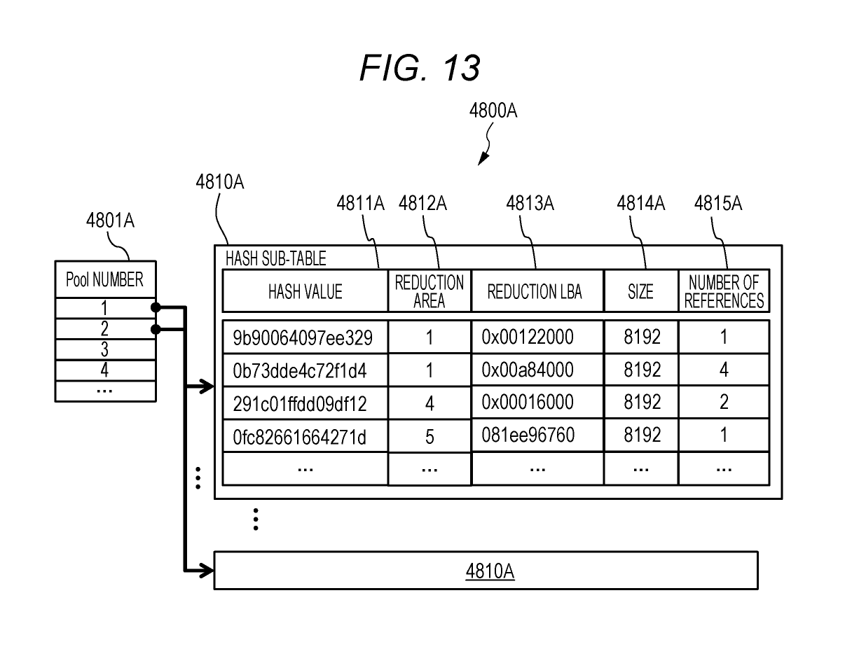

FIG. 13 shows an example of the configuration of the hash table 4800A.

The hash table 4800A includes a hash sub-table 4810A for each entry of the pool number 4801A. The information stored in each entry of the hash sub-table 4810A includes a hash value 4811A, a reduction area 4812A, a reduction LBA 4813A, a size 4814A, and the number of references 4815A.

The hash value 4811A indicates the hash value of the chunk. The reduction area 4812A indicates the identification number of the reduction area 531 to which the reduction LBA storing the chunk (duplication source) used as the hash value belongs.

The reduction LBA 4803A indicates the reduction LBA storing the chunk used as the hash value. The size 4814A indicates the size of the chunk. The number of references 4815A indicates the number of references to the virtual LBA of the HDEV 5301 referring to the chunk.

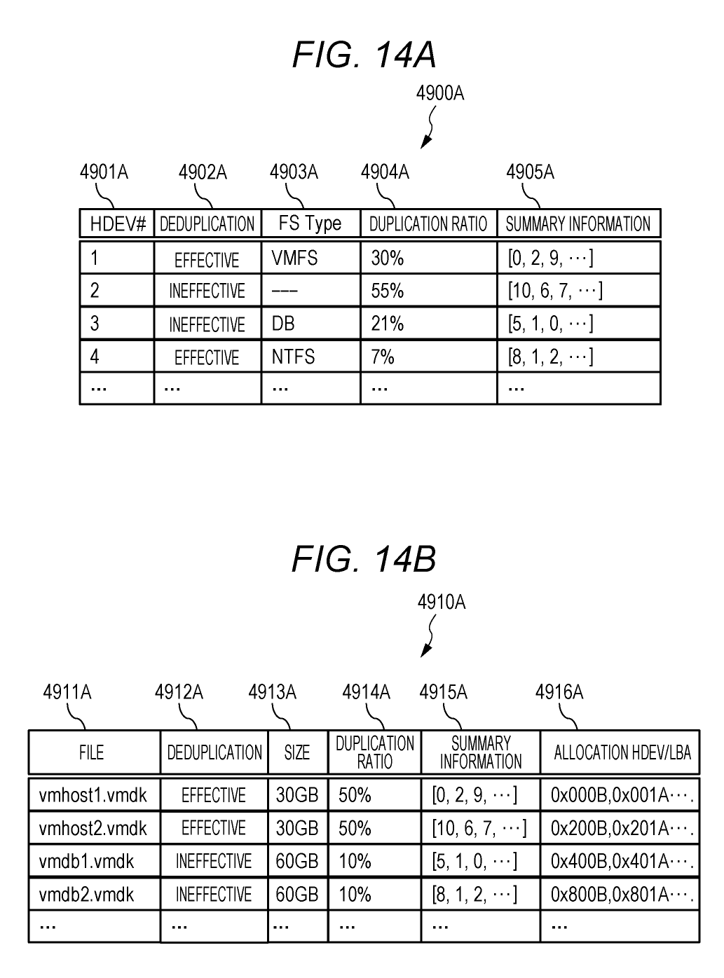

FIG. 14A shows an example of the configuration of the HDEV-duplication-level information table 4900A. FIG. 14B shows an example of the configuration of an HDEV-duplication-level detail information table 4910A.

In the HDEV-duplication-level information table 4900A and the HDEV-duplication-level detail information table 4910A, the duplication-level investigation unit 8000 shown in FIG. 4B stores the duplication ratio of data in each HDEV 5301. In the HDEV-duplication-level information table 4900A, the result of investigating the duplication ratio in an access unit of data for each HDEV 5301 is stored.

In the HDEV-duplication-level detail information table 4910A, the duplication-level investigation unit 8000 analyzes the data of each HDEV 5301, and stores the duplication ratio of each file 5101 included in the file system 5400 used by the host 1003.

An HDEV number 4901A in the HDEV-duplication-level information table 4900A indicates the identification number of the HDEV 5301. A deduplication 4902A is information for determining whether to perform the deduplication processing for the I/O access from the host 1003 having the HDEV number 4901A.

Similar information is in the data reduction mode 4104A in the HDEV management table 4100A, but this item is control information used for the control in the storage, and is different in that the data reduction mode 4104A is a setting item designated by the user operation at the time of configuring the HDEV. An FS Type 4903A indicates the type of the OS executed on the host 1003 using the HDEV 5301 and the type of the file system 5400 used by the VM hypervisor.

A duplication ratio 4904A indicates the data duplication level for each HDEV 5301. Summary information 4905A is summary information obtained when the duplication ratio of the HDEV 5301 is investigated. By comparing the summary information with the summary information of another HDEV 5301, the duplication ratio between the two HDEVs 5301 can be roughly calculated.

The HDEV-duplication-level detail information table 4910A is described. A file 4911A indicates the file name included in the file system 5400 used by the host 1003. Deduplication 4912A is control information for determining whether to perform deduplication processing for the I/O access in file 4911A.

A size 4913A indicates the size of the file included in the file system 5400 used by the host 1003. A duplication ratio 4914A indicates the duplication ratio of each file included in the file system 5400 used by the host 1003. Summary information 4915A indicates summary information of each file. An allocation HDEV/LBA 4916A indicates the HDEV 5301 and the virtual LBA in which each file of the file system 5400 used by the host 1003 is stored.

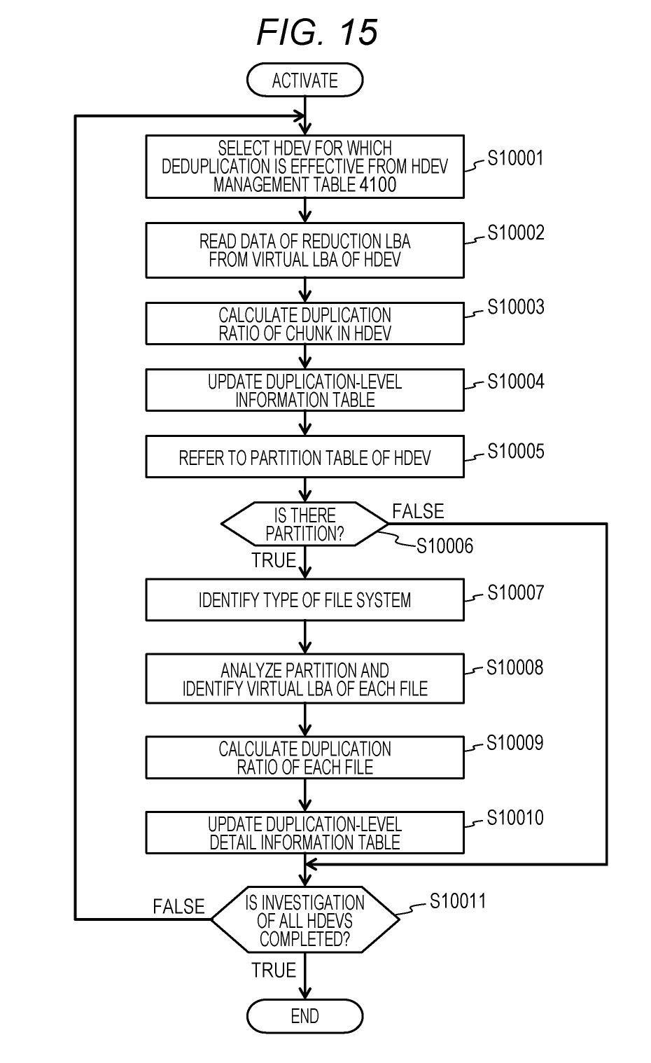

FIG. 15 is a flowchart showing an example of processing of the duplication-level investigation unit 8000.

The duplication-level investigation unit 8000 is activated at a predetermined timing such as when the operation rate of the MPPK 2100 of the storage system 2000 is low or when the load is small because the I/O access from the host 1003 is not frequent. First, in step S10001, the duplication-level investigation unit 8000 refers to the information of the HDEV management table 4100A and selects the HDEV 5301 for which deduplication is effective.

In step S10002, the duplication-level investigation unit 8000 reads, from the HDEV 5301 selected in the previous step, the chunk stored in the storage system 2000 using the virtual LBA.

In step S10003, the duplication-level investigation unit 8000 calculates the duplication ratio of the chunk read in the previous step. To calculate the duplication ratio, a publicly known or well-known method can be used, and data stored in the pool 5501 or a table created reflecting the result of deduplication such as the HDEV physical/logical conversion table 4500A may be investigated. In the present embodiment, a statistical algorithm called the Hyper Log Log (HLL) method is assumed to be used for explanation.

In step S10004, the duplication-level investigation unit 8000 updates the duplication ratio and the summary information of the HLL with respect to the entry of the target HDEV 5301 in the HDEV-duplication-level information table 4900A.

After searching a partition table (not shown) of the HDEV 3501 in step S10005, the duplication-level investigation unit 8000 determines whether there is a partition in step S10006. When there is a partition, the processing proceeds to step S10007, and when there is not, the processing proceeds to step S10011.

In step S10007, the duplication-level investigation unit 8000 identifies the type of the file system of the partition and updates the FS Type 4902 in the HDEV-duplication-level information table 4900A.

The duplication-level investigation unit 8000 analyzes the partition and identifies the virtual LBA corresponding to each file in the partition in step S10008, and calculates the duplication ratio of each file by the above method in step S10009. In step S10009, the duplication-level investigation unit 8000 updates the target entry in the HDEV-duplication-level detail information table 4910 with the information on the file name of each file, the size, the duplication ratio, and the like. In step S10010, the processing is terminated when the duplication-level investigation unit 8000 completes the investigation of all the HDEVs 3501, or the processing returns to step S10001 to repeat the above processing when the duplication-level investigation unit 8000 does not complete. Through the above processing, the duplication ratio of each chunk in the HDEV-duplication-level information table 4900A and the duplication ratio of each file in the HDEV-duplication-level detail information table 4910A are updated.

The above is an example of the processing in the duplication-level investigation unit 8000. However, the information for updating the HDEV-duplication-level detail information table 4910 may be provided from the host 1003, the OS or the hypervisor operating on the host 1003, or a VM or an application operating thereon.

FIG. 16 is a flowchart showing an example of the processing of the deduplication ON/OFF determination unit at the time of writing data.

In step S12001, the deduplication ON/OFF determination unit 9000 calculates, from the virtual LBA of the HDEV 5301 that is the write range of the host 1003, the corresponding reduction area 531 and reduction LBA by referring to the HDEV logical/physical conversion table 4400A.

The deduplication ON/OFF determination unit 9000 refers to the reduction area table 4600A in step S12002, and determines whether the deduplication processing is effective in step S12004. The deduplication ON/OFF determination unit 9000 determines whether the area type 4612A of the reduction area 531 is a DS area (shared area). When the reduction area 531 is a DS area, the processing proceeds to step S12005. When the reduction area 531 is not a DS area, the processing proceeds to step S12011, and the I/O route in which the deduplication processing/address conversion is not performed is selected to terminate the processing.

In step S12005, the deduplication ON/OFF determination unit 9000 determines whether the duplication ratio 4904A is equal to or greater than a predetermined reference value by referring to the HDEV-duplication-level information table 4900A. This reference value may be defined in the control program 3000 of the storage system 2000 in advance or by an instruction from an administrator of the storage system 2000 or from the host 1003.

When the duplication ratio 4904A is less than the reference value, the HDEV 5301 being processed has a low duplication ratio, and the I/O route in which the deduplication processing/address conversion is not performed is selected to terminate the processing.

On the other hand, when the duplication ratio 4904A is equal to or greater than the reference value, it is determined whether the type of the FS used by the HDEV 5301 being processed is known by referring to the FS Type 4902 in the HDEV-duplication-level information table 4900 in step S12006. When the type is known, the processing proceeds to step S12007, and when the type is not known, the processing proceeds to step S12010.

In step S12007, the deduplication ON/OFF determination unit 9000 identifies the file corresponding to the HDEV 5301 being processed and the virtual LBA by referring to the HDEV-duplication-level detail information table 4910.

In step S12009, the deduplication ON/OFF determination unit 9000 determines whether the duplication ratio 4914A of the identified file is equal to or greater than a predetermined reference value by referring to the HDEV-duplication-level detail information table 4910A. When the duplication ratio 4914A is equal to or greater than the predetermined reference value, the processing proceeds to step S12010, and the I/O route in which the deduplication processing/address conversion is performed is selected for the target area of the deduplication processing to terminate the processing.

On the other hand, when the duplication ratio 4914A is less than the reference value, the processing proceeds to step S12011, it is determined that the merit of deduplication is small, and the I/O route in which the deduplication processing/address conversion is not performed is selected for the area to terminate the processing.

Through the above processing, when the duplication ratio 4904A in the HDEV-duplication-level information table 4900A is less than the reference value, the deduplication processing is prohibited although the deduplication 4902A of the access target HDEV number 4901A is effective, and the access is performed through the I/O route in which deduplication processing/address conversion is not performed.

Furthermore, when the duplication ratio 4914A in the HDEV-duplication-level detail information table 4910A is less than the reference value, the deduplication processing is prohibited although the deduplication 4912A of the access target file (or LBA) 4911A is effective, and the access is performed through the I/O route in which deduplication processing/address conversion is not performed.

As described above, with respect to an access target for which the deduplication processing is not effective, it is possible to reduce the overhead of the processing related to the deduplication processing such as duplication determination and address conversion, and to improve the efficiency of the I/O processing.

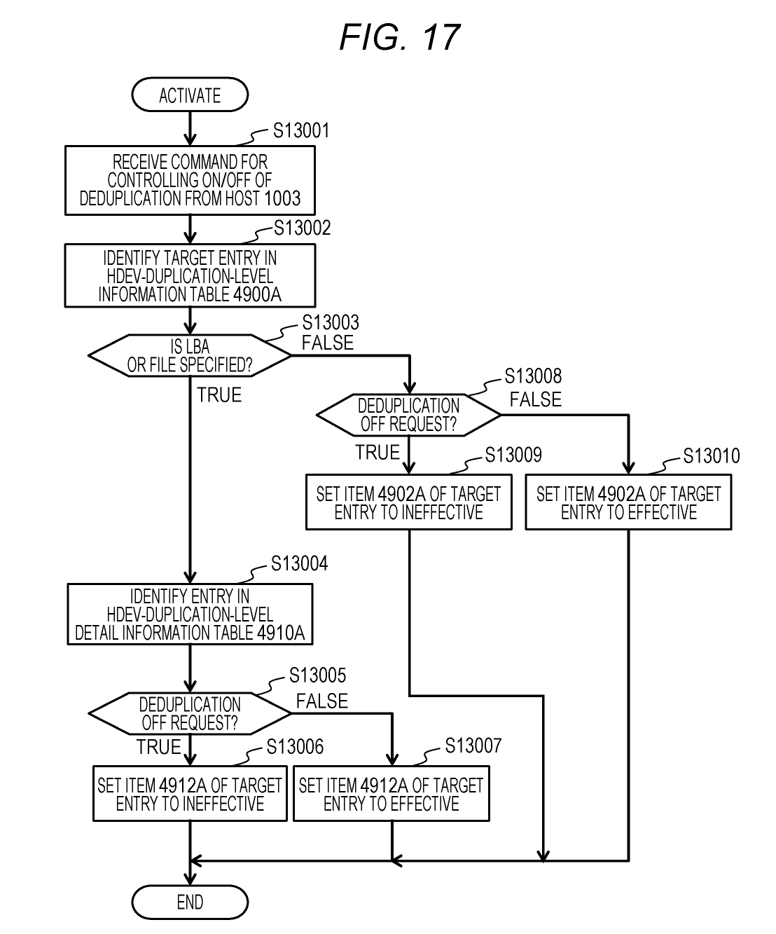

FIG. 17 is a flowchart showing an example of processing in which the host 1003 explicitly notifies the storage system 2000 of the effectiveness or ineffectiveness of the deduplication processing.

In step S13001, the storage system 2000 receives a signal (command) for controlling ON (effectiveness)/OFF (ineffectiveness) of the deduplication processing execution from the connected host 1003 via the interface as shown by a reference sign 803 in FIG. 4B. The interface 803 may be, for example, a physically different communication path or a logical communication path. Alternatively, the interface 803 may be implemented as a command for the host 1003 to operate the storage system 2000 in a protocol such as Fibre Channel (FC) or SCSI connecting the storage system 2000 with the host 1003.

In step S13002, the storage system 2000 identifies the target entry in the HDEV-duplication-level information table 4900A. The command for controlling ON/OFF of the deduplication processing execution includes information for identifying the HDEV 5301 to be controlled, information for identifying the LBA or file to be controlled, and information indicating whether deduplication processing is ON (effectiveness) or OFF (ineffectiveness).

In step S13003, the storage system 2000 determines whether the control target of the received command is in an LBA or file unit or not. When the control target is in the specified range in an LBA or file unit, the processing proceeds to step S13004, and when the control target is in another unit (in a unit of HDEV 5301), the processing proceeds to step S13008.

The storage system 2000 identifies the entry in the HDEV-duplication-level detail information table 4910A in step S13004, and determines whether the command is a deduplication OFF request in step S13005. When the command is a deduplication OFF request, the processing proceeds to step S13006. When the command is not, the processing proceeds to step S13007.

When the command is a deduplication OFF request in step S13005, the storage system 2000 sets the item of the deduplication 4912A in the HDEV-duplication-level detail information table 4910A corresponding to the entry to ineffectiveness (OFF) in step S13005. On the other hand, when the command is a deduplication ON request, the storage system 2000 sets the item of the deduplication 4912A in the HDEV-duplication-level information table 4900A corresponding to the entry is set to effectiveness (ON) in step S13007.

When the target of the command is not in an LBA or file unit but in an HDEV unit in step S13003, it is determined whether the command is a deduplication OFF request in step S13008.

When the command is a deduplication OFF request in step S13008, the storage system 2000 sets the item of the deduplication 4912A in the HDEV-duplication-level detail information table 4910A corresponding to the entry to ineffectiveness in step S13009.

On the other hand, when the command is a deduplication ON request in step S13003, the storage system 2000 sets the item of the deduplication 4912A in the HDEV-duplication-level detail information table 4910A corresponding to the entry to effectiveness in step S13010.

Through the above processing, when receiving the command for setting the deduplication processing to effectiveness or ineffectiveness, the storage system 2000 can set the deduplication processing for the specified control target in an LBA or file unit or in an HDEV unit to effectiveness or ineffectiveness.

Note that, the present invention is not limited to the above embodiment and includes various modifications. For example, the above embodiment has been described in detail in order for the present invention to be easily understood, and is not necessarily limited to those having all the described configurations. Furthermore, a part of the configuration of an embodiment can be replaced with the configuration of another embodiment, and the configuration of an embodiment can be added to the configuration of another embodiment. In addition, to a part of the configuration of the embodiment, addition, deletion, or replacement of other configurations can be applied independently or in combination.

In addition, the above configurations, functions, processing units, processing means, and the like may be implemented by hardware by, for example, designing a part or all of them in an integrated circuit. Alternatively, the above configurations, functions, and the like may be implemented by software by interpreting and executing programs for implementing each function by a processor. Information, such as programs, tables, and files, that implements the functions can be stored in a storage device such as a memory, a hard disk, a solid-state drive (SSD), or a recording medium such as an IC card, an SD card, or a DVD.

Note that, control lines and information lines considered to be necessary for the description are shown, and all control lines and information lines on products are not necessarily shown. In practice, it can be considered that almost all the configurations are mutually connected.

What is claimed is:

1. A storage system having a deduplication function that stores a plurality pieces of data having duplicated content as one piece of data in a storage device, the storage system comprising:
a processor; and
a controller including a memory, wherein
the controller comprises:
a deduplication processing/address conversion unit configured to create a first volume corresponding to an external device that transmits a write request and a read request and a second volume corresponding to the storage device, and to convert an address of data deduplicated between the first volume and the second volume; and
a deduplication determination unit configured to investigate a duplication level of each area of the first volume, and to determine whether deduplication for each area is necessary, and
the controller performs access control to the storage device based on the determination as to whether the deduplication is necessary.

2. The storage system according to claim 1, wherein the controller accesses the storage device via the deduplication processing/address conversion unit when the deduplication for an area of the first volume in the access request from the external device is necessary, and accesses the storage device not via the deduplication processing/address conversion unit when the deduplication is unnecessary.

3. The storage system according to claim 2, wherein the controller moves, when the deduplication for an area in which the deduplication function has operated is determined to be unnecessary, data in the area stored in the storage device so as to cancel the deduplication for the data, and accesses, after the deduplication has been cancelled, the storage device not via the deduplication processing/address conversion unit.

4. The storage system according to claim 1, wherein the deduplication determination unit investigates the duplication level in an access unit to the first volume and determines whether the deduplication is necessary.

5. The storage system according to claim 4, wherein an access unit is a data chunk.

6. The storage system according to claim 1, wherein the deduplication determination unit investigates the duplication level in a file unit to be stored in the first volume and determines whether the deduplication is necessary.

7. A method of controlling a storage system that comprises a processor and a controller including a memory and has a deduplication function that stores a plurality pieces of data having duplicated content as one piece of data in a storage device, the method comprising:
a first step of, by the controller, creating a first volume corresponding to an external device that transmits a write request and a read request and a second volume corresponding to the storage device;
a second step of, by the controller, investigating a duplication level of each area of the first volume, and determining whether deduplication for each area is necessary; and
a third step of, by the controller, performing access control to the storage device based on the determination as to whether the deduplication is necessary, and
the third step includes an address conversion step of converting an address of data deduplicated between the first volume and the second volume.

8. The method of controlling the storage system according to claim 7, wherein
the third step further includes:
accessing the storage device after performing the address conversion step when the deduplication for an area of the first volume in the access request from the external device is necessary; and
accessing the storage device without performing the address conversion step when the deduplication is unnecessary.

9. The method of controlling the storage system according to claim 8, wherein
the third step further includes:
moving, when the deduplication for an area in which the deduplication function has operated is determined to be unnecessary, data in the area stored in the storage device so as to cancel the deduplication for the data; and
accessing, after the deduplication has been cancelled, the storage device without performing the address conversion step.

10. The method of controlling the storage system according to claim 7, wherein the second step further includes investigating the duplication level in an access unit to the first volume and determining whether the deduplication is necessary.

11. The method of controlling the storage system according to claim 10, wherein an access unit is a data chunk.

12. The method of controlling the storage system according to claim 7, wherein
the second step further includes investigating the duplication level in a file unit to be stored in the first volume and determining whether the deduplication is necessary.
